(19) United States
(12) Patent Application Publication
(10) Pub. No.: US 2015/0259941 A1
(43) Pub. Date: Sep. 17, 2015

(54) Self Contained Vehicle Repair Shop

(71) Applicant: Halo Accident Repair Centre Limited, Surrey, Ot (GB)

(72) Inventor: Bradley James Hanson, West Sussex (GB)

(73) Assignee: Halo Accident Repair Centre Limited, Surrey (GB)

(21) Appl. No.: 14/372,317

(22) PCT Filed: Feb. 5, 2013
(86) PCT No.: PCT/GB2013/000045

§ 371 Date: Jul. 15, 2014

(30) Foreign Application Priority Data
Feb. 6, 2012 (GB) 1202065.7

(51) Int. Cl. E04H 6/30; B60S 5/00; B60S 13/00; E04H 5/06

(52) U.S. Cl. CPC E04H 6/30; E04H 5/06; B60S 5/00; B60S 13/00

(57) ABSTRACT

A preliminary bay is provided inwards of entry door and the entry ramp on the entry path. A conveyor provides movement of the vehicle laterally to the next bay, arranged at right angles to the entry path; a panel repair and priming bay is to the side of the preliminary bay on the conveyor. Entry doors and exit doors are provided across the conveyor. After the vehicle has been worked on it is moved sideways out of the bay to the next bay; a painting bay is provided next along the conveyor. Work preparatory to painting not carried out in bay is carried out in it together with painting. The bay has an exit door; A mop and fit bay is provided on the intersection of the conveyor and the exit path. Remedial work as might have been carried out in the jail bay is carried out here.

The present invention relates to a self-contained vehicle repair shop.

Traditionally vehicle repair shops have been arranged as general purpose work bays within a building, albeit with specialist bays within the building in particular paint ovens. Such a traditional arrangement does not lend itself to “lean” techniques allowing enhanced through-put of vehicles being repaired and reduced repair time from accident to return of the vehicle to the owner. This is despite the economic pressure from insurers for whom repair time as such is costly in terms of temporary replacement cars for instance.

The object of the present invention is to provide a self-contained vehicle repair shop facilitating improved repair time.

According to the invention there is provided a self-contained, vehicle-repair-shop building having its own floor, roof and walls, the vehicle-repair-shop building comprising:

an array of at least four repair-work bays in the following order:

1. a preliminary repair-work bay,

2. a priming repair-work bay equipped for applying primer to a vehicle and drying the primer,

3. a painting repair-work bay equipped for applying a top coat of paint to a vehicle and drying the paint and

4. a final repair-work bay,

the array providing:
a repair-work route for a vehicle being repaired to follow through the bays in their order;

a vehicle entry, providing a forwards or reverse entry path to the repair-work route;

a separate vehicle exit, providing a forwards or reverse exit path from the repair-work route, parallel to but spaced from the entry path; and

at least one conveyor for conveying a vehicle laterally between at least two of the repair-work bays from the entry path to the exit path along at least a part of the repair-work route.

The four repair-work bays can be provided in a square-array in which case two are provided on the entry path and two are provided on the exit path. In this square-array, embodiment, normally the conveyor will be provided between the priming bay and the painting bay, which are themselves provided on the entry and exit paths on the respective opposite ends of the preliminary and final bays from the entry and exit. Possibly a second conveyor can be provided between the preliminary and final bays. This can be the only conveyor but is inconvenient in this position. Thus with this array, the repair-work route is usually provided by the entry path between preliminary and priming bays, the conveyor between the priming bay and the painting bay and the exit route between the painting bay and the final bay.

In another, linear-array, embodiment, the four repair-work bays are provided laterally in line, with the conveyor extending through all four. In this embodiment, the priming and painting bays are between the preliminary and final bays along the repair-work route which is defined by the conveyor.

Whilst it is conceivable, particularly in the linear-array embodiment described below that the vehicle entry and exit could be on opposite sides of the building, with forwards (or reverse) entry on one side of the building at one end of the linear-array, and forwards (or reverse) exit on another side of the building at the other end of the linear-array, preferably the vehicle entry and exit are on the same side or end of the building with forwards (or reverse) entry and reverse (or forwards) exit. Normally this same side will be a front side, with a customer reception area between the entry and exit and a service area behind the repair-work bays at the back of the building.

In the first preferred embodiment described in more detail below, having two conveyors, two extra repair-work bays are provided along the conveyors for performing work preliminary to priming and preliminary to painting and possibly remedial-following-repair work. This is referred to below as the rectangular array. Further, in the square and rectangular arrays, two additional minor-work bays can be provided externally of the entry to and exit from the repair-work bays. Insofar as these minor-work bays can be provided inside external walls of the building, of which three bound the four or six bays, the fourth wall having the entry and exit can be an internal wall. An office bay/customer reception area can be provided between the minor-work bays in the square and rectangular arrays at the front of the building.

Further, internally accessible sub-divisions such as a paint mixing room and lavatories can be provided, particularly off the bay between the priming and painting bays and off the office bay. In addition, externally accessible sub-divisions such as a compressor room can be provided again extending into the bay between the priming and painting bays. Such service areas are preferably provided at the back of the building, except for lavatories at the front off the customer reception area.

In a linear-array embodiment, no separate minor-works bays are provided, with the intention that any actual minor works carried performed outside the building, such as washing, or inside in one of the repair-work bays, such as quality inspection. Nevertheless minor-works bays can be provided on the entry and exit paths of a linear-array embodiment, although this is not the case in the second preferred embodiment described below. In this embodiment, entry and exit ramps are provided within the scantlings of the walls and an office bay, together with lavatories and a paint store and mixing room, are all provided between the entry and exit.

Preferably, the repair shop will have a raised floor with services provided beneath the floor.

Normally, the repair shop will be constructed of pre-fabricated walls and other structural parts. In the preferred embodiment it is constructed on a pallet, being one of the pre-fabricated parts.

To help understanding of the invention, two specific preferred embodiments thereof will now be described by way of example and with reference to the accompanying drawings, in which:

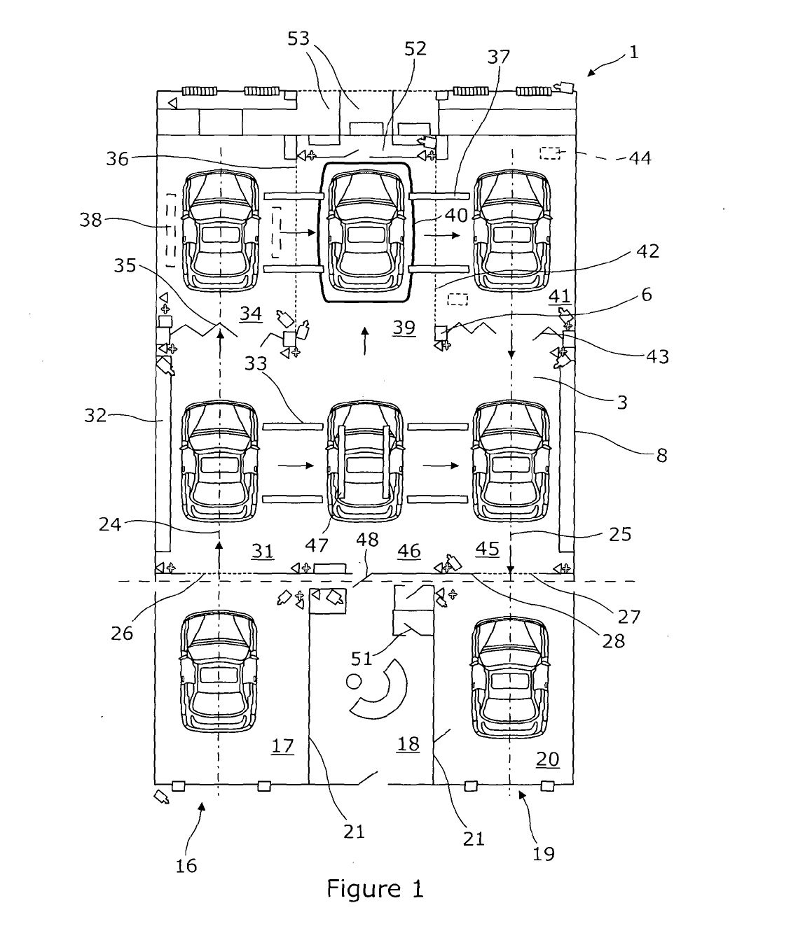

FIG. 1 is a plan view of a self-contained, rectangular-array, vehicle-repair-shop building in accordance with the invention;

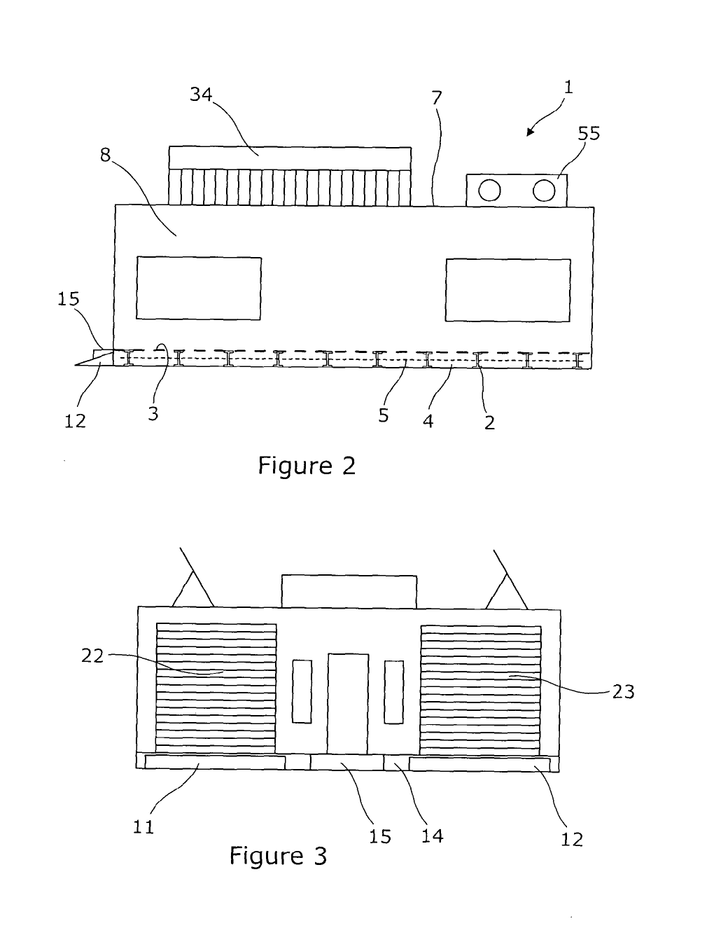

FIG. 2 is a side view of the vehicle repair shop of FIG. 1;

FIG. 3 is an end view of the vehicle repair shop of FIG. 1;

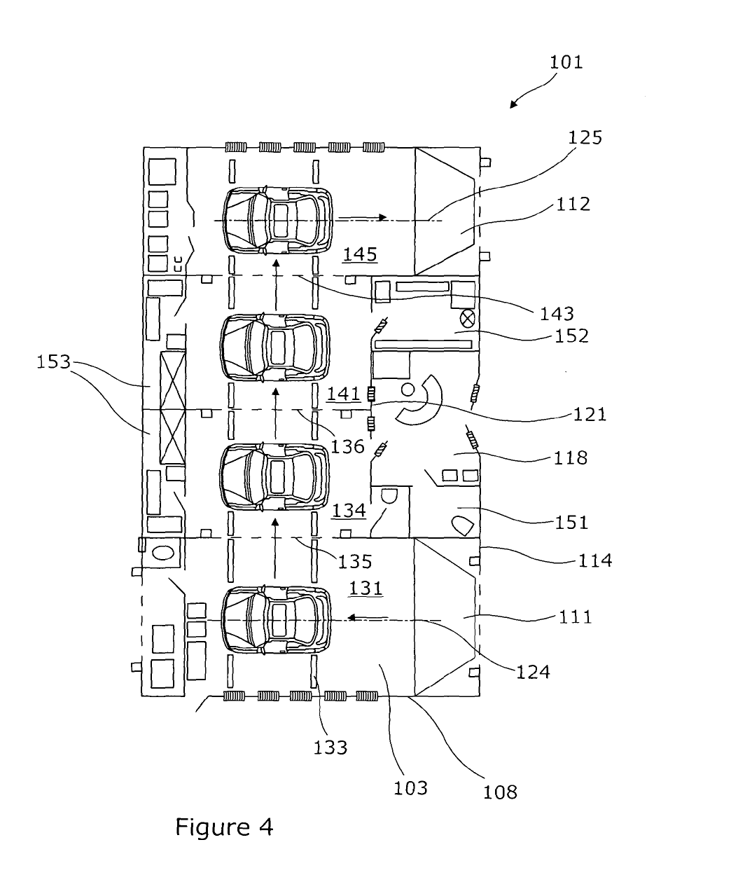

FIG. 4 is a plan view of a second self-contained, linear-array, vehicle-repair-shop building in accordance with the invention;

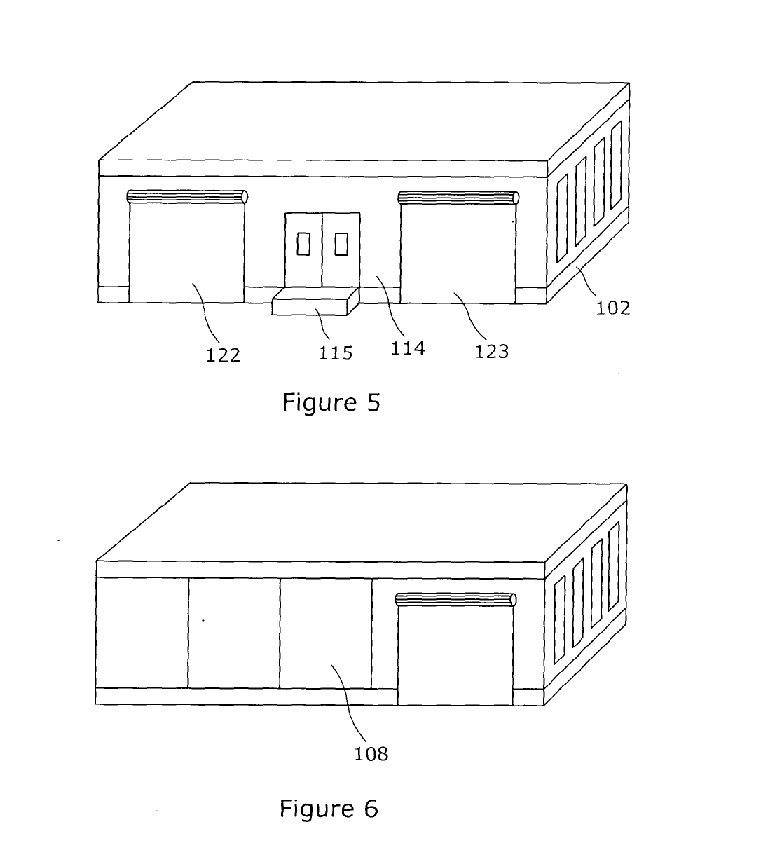

FIG. 5 is a perspective front view of the vehicle-repair-shop of FIG. 4;

FIG. 6 is a perspective rear view of the vehicle-repair-shop of FIG. 4;

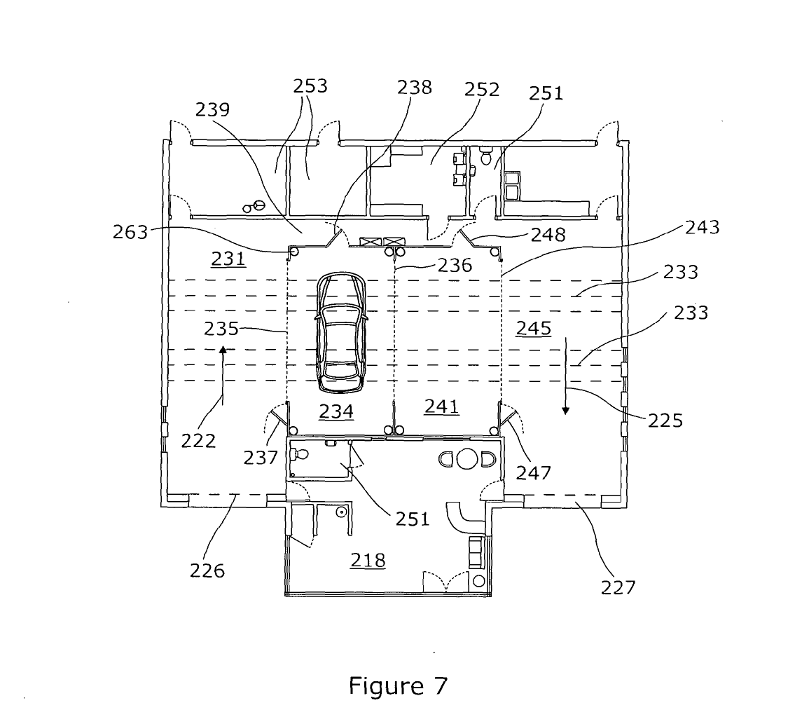

FIG. 7 is a plan view similar to FIG. 4 of a variant of the second vehicle-repair-shop building;

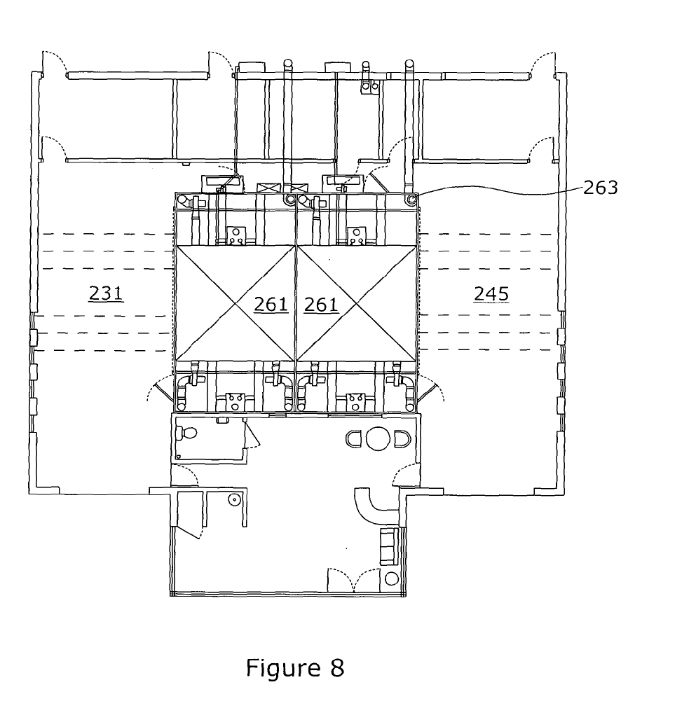

FIG. 8 is a ceiling level view of the variant of FIG. 7 and

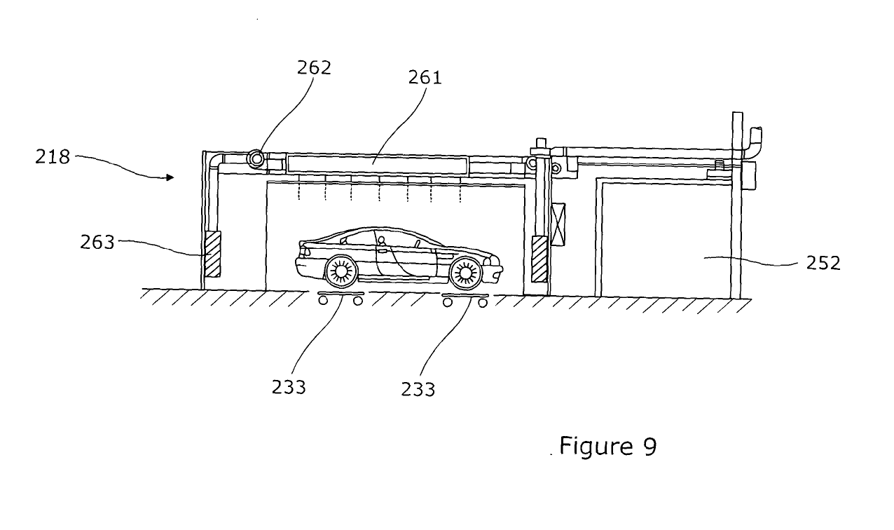

FIG. 9 is a cross-section view of a painting bay of the variant showing a car in the bay.

Referring to FIGS. 1 to 3 of the drawings, the vehicle repair shop 1 there shown is self-contained in that it is separate from any other, conventional building. It is prefabricated with a RSJ pallet 2 supporting a raised floor 3 and providing under floor space 4 for service ducting 5 such as for electrical power, compressed air and extraction. A steel column framework 6 supports a roof 7 with external walls 8 between the columns, a major proportion of the walls being of glass.

The pallet being 300 mm deep, vehicle entry and exit ramps 11,12 are provided at one end 14 of the pallet with a pedestrian step 15 between the ramps. At the entry corner 16 of the pallet/repair shop is a vehicle wash bay 17—washing being a minor work. Non-shown washing and drying equipment and drains via the under floor space are provided. Central of the end 14 is a customer reception/manager's office bay 18 and at the exit corner 19 is an inspection bay 20—inspection also being a minor work. Internal walls 21 divide the minor work bays from the reception bay. Entry and exit roller doors 22,23 are provided to the minor works bays. These define entry and exit paths 24,25.

Further internal entry and exit doors 26,27 to repair-works bays are provided in an internal wall 28 dividing the minor works bays 17,18,20 from six repair-work bays now described. These are provided two along the paths 24,25 and three laterally from one path to the other. The repair-work bays are:

A preliminary bay 31, provided inwards of the entry door 26 on the entry path 22. Here the scope of the work required and the parts & labour to be invoiced are confirmed. The bay is equipped with non-shown tools and a work bench 32 for removal of all parts having to be removed to allow panel repairing and priming work to be performed in the next bay. It can be mentioned here that the door 26 from the wash bay 17 and indeed the wash bay's entry door 22 are of rust resistant material. In case for any reason a vehicle V being worked on needs to be returned laterally to the preliminary bay, a conveyor 33, arranged laterally of the entry path 22 across the pallet, is provided;

A panel repair and priming bay 34 is provided beyond the preliminary bay on the entry path 24 at its corner of the pallet. Entry doors 35 on the path 24 and exit doors 36 parallel to the path across a second conveyor 37 are provided, whereby the bay can be closed. Should the vehicle being worked on need one or more panels filling, filler is applied in this bay. Dust from set and rubbed down filler is extracted via a floor mounted extractor vent 38. Panels requiring priming following such work are primed in this bay. New panels may be required and are fitted in this bay. The vehicle will have been arranged on the conveyor 37 on entry into the bay and is moved sideways out of the bay to the next bay;

A preparation bay 39 is provided on the conveyor through the doors 36. This bay is provided with a lowerable, roof mounted, infra-red heating array 40 for curing primer from the priming bay. Other work preparatory to painting, such as masking, is carried out in this bay;

A painting bay 41 is provided at its corner of the pallet, at the end of the lateral conveyor 37 and on the exit path 25. The vehicle enters the bay on the conveyor via entry doors 42 across the conveyor, with the bay being closed by exit doors 43 across the exit path 25. The bay is a paint oven in which painting as required is performed and an the paint cured with hot air, introduced and exhausted via roof ducts 44;

A mop and fit bay 45 is provided on the exit path 25 between the paint bay exit doors 43 and the repair-works exit doors 23. This bay is equipped for mopping of the paint and refitting or indeed replacement of parts removed for painting.

Certain parts, for instance a new bonnet, can be pre-painted before delivery to the repair shop and these are fitted in this bay;

A so-called jail bay 46 is provided between the bays 31 and 45 for unusual work, such as glass fitting, chassis work and possibly remedial work. The vehicle can be moved to this bay on the conveyor 33 from either of the preliminary bay 31 or the mop & fit bay 45. This bay is equipped with a vehicle lift 47 has a door 48 accessing the office bay 18.

On the exit path, outside the doors 27 is a minor works the inspection bay 20 whence the repaired car can be reversed down the exit ramp 12.

It will be appreciated that the arrangement of the repair-works bays in a rectangular arrangement allows a vehicle being repaired to be simply moved from bay to bay as its repair progresses. Except for the priming and painting bays 39,41 being closable by their doors, the other bays are open to each other and are not physically delimited from each other.

Ancillary spaces provided on the pallet are:

Lavatories 51 in the office bay 18,

Paint preparation and store room 52 in the preparation bay 39;

External stores and services rooms 53 outside the bays 34,39,40.

The invention is not intended to be restricted to the details of the above described embodiment. For instance, the roof of the repair shop can be provided with solar panels 54 to provide at least part of the power required for the work being carried out. Heat exchangers 55 can be provided for recovering heat from air drawn from the priming bay and heating fresh air supplied to it. Further for a small installation, the wash bay 17 and the inspection bay 20 can be dispensed with as can the jail bay 46 and the preparation bay 39. The vehicle repair shop then reduces to a square array of the four basic bays:

Preliminary bay 31,

Panel repair and priming bay 34,

Painting bay 41,

Mop and fit bay 45.

Referring to FIGS. 4 to 6 of the drawings, the vehicle repair shop 101 is also self-contained, being prefabricated with a RSJ pallet 102 supporting a raised floor 103 and external walls 108.

Vehicle entry and exit ramps 111,112 are provided at one side 114 of the pallet within in its scantlings as is an external pedestrian step 115 between the ramps. Central of the side 114 is a customer reception/manager's office bay 118. Internal walls 121 divide the reception bay from the internal of the building, divided into repair-works bays as described below. Entry and exit roller doors 122,123 are provided in the wall of the side 114. These doors and ramps define entry and exit paths 124,125.

The repair-work bays are:

A preliminary bay 131, provided inwards of the entry door 126 and the entry ramp 111 on the entry path 122. This bay has the same use as the preliminary bay 31. For movement of the vehicle laterally to the next bay a conveyor 133, arranged at right angles to the entry path 122, is provided;

A panel repair and priming bay 134 is provided to the side of the preliminary bay on the conveyor 133. Entry doors 135 and exit doors 136 are provided across the conveyor, whereby the bay can be closed. Again work carried out in bay 34 can be carried out in bay 134, together with part of the work carried out in bay 39. After the vehicle has been worked on here it is moved sideways out of the bay to the next bay;

A painting bay 141 is provided next along the conveyor 133. Work preparatory to painting not carried out in bay 134 is carried out in it together with painting as in bay 41. The bay has an exit door 143;

A mop and fit bay 145 is provided on the intersection of the conveyor 133 and the exit path 125. Remedial work as might have been carried out in the jail bay 46 is carried out here. This shop has no facility for the heavier work able to be carried out in the jail bay.

Ancillary spaces provided on the pallet are:

Lavatories 151 off the office bay 118,

Paint preparation and store room 152 off the painting bay 141;

External stores and services rooms 153 outside the bays 131,133,141,145.

A variant of the linear-array, embodiment of FIGS. 4 to 6 is shown in FIGS. 7 to 9. The primary difference in the variant is that the vehicle repair shop is a conventional building as opposed to one provided on a pallet. It comprises:

A preliminary bay 231, provided inwards of the entry door 226 the entry path 222. No ramp onto a raised floor is required. This bay has the same use as the preliminary bays 31,131. For movement of the vehicle laterally to the next bay a conveyor 233, arranged at right angles to the entry path 222, is provided;

A panel repair and priming bay 234 is provided to the side of the preliminary bay on the conveyor 233. An entry doors 235 and an inter-bay doors 236 are provided across the conveyor, whereby the bay can be closed. Again work carried out in bay 34 can be carried out in bay 234, together with part of the work carried out in bay 39. The bay 234 and the next bay 242 are both configured as a self-contained pair of drying ovens. Apart from the vehicle doors 235, 236 the bay has one pedestrian door 237 into the bay 231 and another 238 into a passage 239 bypassing the bay 234. After the vehicle has been worked on here it is moved sideways out of the bay to the next bay;

A painting bay 241 is provided next along the conveyor 233 and being the other bay of the pair of drying ovens. Work preparatory to painting not carried out in bay 234 is carried out in it together with painting as in bay 41. The bay has a vehicle exit door 243 and pedestrian doors 247,248 equivalent to the doors 237,238. Both bays 234,241 are provided with ceiling mounted drying air plenum chambers 261 and blowers 262 and extractors 263 in the corners of the bays;

A mop and fit bay 245 is provided on the intersection of the conveyor 233 and the exit path 225, which passes through the door 227. Remedial work as might have been carried out in the jail bay 46 is carried out here. This shop has no facility for the heavier work able to be carried out in the jail bay.

Ancillary spaces are provided:

Reception 218,

Lavatories 251 off the office bay 218 and the passage 239,

Paint preparation and store room 252 off the passage 239;

Stores and services rooms 253.

1. A self-contained, vehicle-repair-shop building having its own floor, roof and walls, the vehicle-repair-shop building comprising:
an array of at least four repair-work bays in the following order:
1. a preliminary repair-work bay,
2. a priming repair-work bay equipped for applying primer to a vehicle and drying the primer,
3. a painting repair-work bay equipped for applying a top coat of paint to a vehicle and drying the paint and
4. a final repair-work bay,
the array providing:
a repair-work route for a vehicle being repaired to follow through the bays in their order;
a vehicle entry, providing a forwards or reverse entry path to the repair-work route the vehicle entry having a door in the building wall across the entry path;
a separate vehicle exit, providing a forwards or reverse exit path from the repair-work route, parallel to but spaced from the entry path;, having a door in the building wall across the exit path;
both the vehicle entry and vehicle exit being on the same side or end of the building with forward (or reverse) entry and reverse (or forwards) exit;
at least one conveyor for conveying a vehicle laterally between at least two of the repair-work bays from the entry path to the exit path along at least a part of the repair-work route, and the conveyor being arranged at least substantially at right angles to the entry and exit paths and extending the whole distance from the entry path to the exit path; and
an office bay/customer reception area between the entry and exit.

2. (canceled)

3. (canceled)

4. A building according to claim 1, including a service area behind the repair-work bays.

5. (canceled)

6. A building according to claim 1, wherein the four repair-work bays are provided laterally in line, in a linear array, with the conveyor extending through all four, with the priming and painting bays between the preliminary and final bays along the repair-work route which is defined by the conveyor.

7. A building according to claim 1, wherein the four repair-work bays are provided in a square-array in which two of the repair-work bays are provided on the entry path and the other two repair-work bays are provided on the exit path.

8. A building according to claim 7, wherein the conveyor is provided between the priming bay and the painting bay, which are themselves provided on the entry and exit paths on the respective opposite ends of the preliminary and final bays from the entry and exit, the repair-work route being provided by the entry path between preliminary and priming bays, the conveyor between the priming bay and the painting bay and the exit route between the painting bay and the final bay.

9. A building according to claim 8, wherein a second conveyor is provided between the preliminary and final bays.

10. A building according to claim 9, wherein two extra repair-work bays are provided along the conveyors providing a rectangular array of repair-work bays.

11. A building according to claim 1, including two additional minor-work bays provided externally of the entry to and exit from the repair-work bays.

12. A building according to claim 11, wherein the two minor-work bays are provided inside external walls of the building and are divided from the repair-work bays by an internal wall of the building, the entry and exit to the repair route being provided in the internal wall and the repair-work bays being within three of the external walls of the building.

13. A building according to claim 12, wherein the office bay/customer reception area is between the minor-work bays.

14. A building according to claim 2, wherein the service area includes a paint mixing room and a compressor room.

15. A building according to claim 1, wherein the building is a pre-fabricated building constructed on a pallet providing a raised floor and having service ducts within the depth of the pallet.
